(19) United States
(12) Patent Application Publication
(10) Pub. No.: US 2025/0243429 A1
(43) Pub. Date: Jul. 31, 2025

(54) HDL CONCENTRATE-MILD, PG-FREE, LAS-FREE, SELF-PRESERVED WITH AMINE BUFFER AND SACCHARIDE DERIVATIVE

(71) Applicant: Henkel AG & Co. KGaA, Duesseldorf (DE)

(72) Inventor: Daniel Thomas Piorkowski, Trumbull, CT (US)

(21) Appl. No.: 18/986,034

(22) Filed: Dec. 18, 2024

Related U.S. Application Data
(60) Provisional application No. 63/613,841, filed on Dec. 22, 2023.

(51) Int. Cl. C11D 1/722; C11D 1/12; C11D 1/83; C11D 3/20; C11D 3/22; C11D 3/30

(52) U.S. Cl. CPC C11D 1/722; C11D 1/12; C11D 1/83; C11D 3/2065; C11D 3/221; C11D 3/30; C11D 2111/12

(57) ABSTRACT

A self-preserved liquid detergent composition useful for laundry applications is disclosed. The liquid detergent composition has a water activity that enables it to be self-preserving, and it does not contain a linear alkylbenzene sulfonate, a preservative, or propylene glycol, thus improving mildness. The liquid detergent composition further comprises a saccharide derivative comprising a non-reducing sugar or sugar alcohol such as sorbitol thus enabling the composition to not undergo browning reactions with amines such as found when proteins, amino acids and the like are encountered in laundry applications.

### BACKGROUND

Mildness, which relates to the reduction of skin irritation, is a significant consumer need and driver for laundry detergent purchase. Current commercially available laundry detergents include formulations free of dyes and perfumes, which can cause skin irritation. Other causes of skin irritation in laundry detergents include certain surfactants, preservatives, and stabilizers such as propylene glycol. A variety of test methods as described, for example, in U.S. Published Patent Application No. 2018/0016523 are used to evaluate skin irritancy in laundry detergent use settings. Such methods include the Zein test as known in the art, which measures skin irritancy potential by determining the extent of denaturation of the Zein corn protein after exposure to a surfactant, as would be found in laundry detergents, for a given period of time. Another test to measure the skin irritancy is the corneosufametry (CSM) test as known in the art which is a non-invasive test quantitative test that measures the interaction between surfactants and human stratum corneum. Still another method to assess skin irritancy is the cytokine test as known in the art, which measures the cytokine release of representative human skin models in response to a surfactant-containing formulation. The aggregate of such test scores can be used to determine the mildness of the laundry detergent for the consumer.

Included among common surfactants used in laundry detergents are linear alkylbenzene sulfonates (LAS). The LAS are a class of anionic surfactants that are known to be advantageously biodegradable, but they are not as mild a surfactant as desired. Also present in typical laundry detergents are preservatives, such as isothiazolinones including such compounds as methylisothiazolinone (MIT), benzisothiazolinone (BIT) and chloromethylisothiazolinone (CIT), which are added to forestall proliferation of bacteria, yeast and/or mold that could otherwise attend the formulation. However, preservatives can be sensitizing and cause skin irritation. Stabilizers are often also used in laundry detergents to keep the ingredients from separating. A commonly employed stabilizer is propylene glycol (PG), which compound can cause skin irritation and allergic reactions.

There is thus a need for a detergent composition of improved mildness by not containing a preservative and is instead self-preserved, and which does not contain LAS, and which does not contain propylene glycol.

### SUMMARY

A self-preserved liquid detergent composition useful for laundry applications is provided. The self-preserved liquid detergent composition of the disclosure does not contain any of the following: (i) a linear alkylbenzene sulfonate, (ii) a preservative, and (iii) propylene glycol. The liquid detergent composition of the disclosure is self-preserved by comprising an amount of water sufficient to provide a water activity of between about 0.65 to about 0.8, at which available water level mold, yeast, and bacteria cannot survive. In one embodiment, the detergent composition of the disclosure is a concentrated liquid detergent and is not a unit dose product wherein the detergent composition is encapsulated in a small container typically made of polyvinyl acetate (PVA) film. In this liquid detergent embodiment, glycerin can be employed since otherwise unwanted interactions of glycerin with the encapsulating unit dose film is not a concern. The ability to use glycerin assists in maintaining the water activity at the target level of between about 0.65 to about 0.8. Preservatives which are absent from the self-preserved liquid detergent composition include those known in the art such as without limitation isothiazolinones, including methylisothiazolinone, benzisothiazolinone, chloromethylisothiazolinone and the like. In one practice, the liquid detergent composition of the disclosure is a concentrate that is about 2 to about 4 times more concentrated than known standard detergents, e.g. those that are 1.5 fluid ounces per dose. The liquid detergent composition of the disclosure comprises a saccharide derivative which enables the composition to not undergo browning reactions with amines such as found when proteins, amino acids and the like are encountered in laundry applications. The saccharide derivative comprises a non-reducing sugar or sugar alcohol, such as sorbitol, or combinations thereof.

In one aspect, the disclosure provides a self-preserved liquid detergent composition useable as a non-unit dose embodiment. In one embodiment, the liquid detergent composition comprises glycerin; at least one saccharide derivative; least one surfactant; at least one amine buffer or an inorganic pH adjusting agent; and water in an amount effective to provide a water activity of between about 0.65 to about 0.8, wherein the liquid detergent composition does not contain any of the following: (i) a linear alkylbenzene sulfonate, (ii) a preservative, and (iii) propylene glycol.

In other embodiments, the self-preserved liquid detergent composition consists essentially of glycerin; at least one saccharide derivative; at least one surfactant; at least one amine buffer or an inorganic pH adjusting agent; and water in an amount effective to provide a water activity of between about 0.65 to about 0.8, wherein the liquid detergent composition does not contain any of the following: (i) a linear alkylbenzene sulfonate, (ii) a preservative, and (iii) propylene glycol.

In yet further embodiments, the liquid detergent composition consists of glycerin; at least one surfactant; at least one saccharide derivative; at least one amine buffer or an inorganic pH adjusting agent; and water in an amount effective to provide a water activity of between about 0.65 to about 0.8, wherein the liquid detergent composition does not contain any of the following: (i) a linear alkylbenzene sulfonate, (ii) a preservative, and (iii) propylene glycol.

In various embodiments the water activity is between about 0.65 to about 0.75; in other embodiments the water activity is between about 0.66 to about 0.7.

In select embodiments herein the water is present at about 10 wt % to about 40 wt %, or water is present at about 15 wt % to about 30 wt %, the wt % based on the total weight of the liquid detergent composition.

In other embodiments, the ratio of glycerin to water is about 60 to about 40; in other embodiments the ratio of glycerin to water is about 55 to about 45. In some embodiments, the non-aqueous solvent further comprises a polyethylene glycol in addition to glycerin.

In some embodiments herein the amine buffer comprises monoethanolamine, triethylamine, or mixtures thereof; and the inorganic pH adjusting agent comprises sodium hydroxide. In other embodiments, the liquid detergent composition further comprises an anionic surfactant. In still other embodiments, the liquid detergent composition further comprises a chelating agent.

### DETAILED DESCRIPTION

The entire contents of U.S. Published Patent Application No. 2018/0016523 are incorporated herein by reference for any purpose.

The present disclosure will now be described in greater detail by referring to the following discussion. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) and includes endpoints and includes any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

The self-preserved liquid detergent of the present disclosure can be used in non-unit dose form and comprises glycerin; at least one saccharide derivative; at least one surfactant; at least one amine buffer or an inorganic pH adjusting agent; and water in an amount effective to provide a water activity of between about 0.65 to about 0.8, wherein the liquid detergent composition does not contain any of the following: (i) a linear alkylbenzene sulfonate, (ii) a preservative, and (iii) propylene glycol.

In one practice, the water in the concentrated liquid detergent composition can be derived from added water and water that accompanies a component that forms the raw material that is used in formulating the detergent composition. In the concentrated liquid detergent of the disclosure, water is present in an amount effective to provide a water activity of between about 0.65 to about 0.8. In other embodiments, the water activity is between about 0.65 to about 0.75. In still other embodiments, the water activity is between about 0.66 to about 0.7.

Water activity is a known measure of the freely available water in a material and indicates the availability of the water for chemical, biochemical, and microbial reactions. Water activity is stated as an “a_{w}” value and is defined as the quotient of the concentration of water in the vapor phase in the airspace over the liquid detergent composition and the water concentration in the airspace over pure water at a specific temperature, e.g. 25° C.: a_{w}=p/p₀.

In one practice, the total water amount present in the liquid detergent composition is up to about 45 weight percent; in another practice, water is present from about 5 weight percent to about 45 weight percent, more typically from about 10 weight percent to about 40 weight percent even more typically from about 20 weight percent to about to about 35 weight percent more typically from about 25 weight percent to about 35 weight percent, based on the total weight of the detergent composition.

In other embodiments, water is present in an amount of from about 5 weight percent to about 10 weight percent, from 10 weight percent to about 15 weight percent, from about 15 weight percent to about 20 weight percent, from about 20 weight percent to about 25 weight percent, from about 25 weight percent to about 30 weight percent, from 30 weight percent to about 35 weight percent, from about 35 weight percent to about 40 weight percent, or from about 40 weight percent to about 45 weight percent, based on the total weight of the liquid detergent composition.

In embodiments of the liquid detergent composition of the disclosure, glycerin is present in some practices at about 15 weight percent to about 40 weight percent, and at about 25 weight percent to about 40 weight percent, the weight percentages based on the total weight of the liquid detergent composition.

In other embodiments, the ratio of glycerin to water is from 4:1 to 1:4, from 3:1 to 1:3, from 3:1 to 1:2, from 2:1 to 1:2, about 1.2:1 or about 1:1. In other embodiments, the weight ratio of glycerin to water is from 1:1 to 1:4, from 1:1 to 1:3, or from 1:1 to 1:2. In further embodiments, the weight ratio of glycerin to water is about 1:0.5, about 1:0.8, about 1:1, about 1:1.2, about 1:13, or about 1:1.5.

In embodiments of the liquid detergent composition of the disclosure, the saccharide derivative comprises a non-reducing sugar, a sugar alcohol, or combinations thereof. Without limitation, the saccharide derivative can comprise sorbitol, xylitol, mannitol, lactitol, isomalt, maltitol, a hydrogenated starch hydrolysate, sucrose, stachyose, verbascose, trehalose, raffinose or combinations. In various embodiments, the saccharide derivative is present up to about 30 weight percent, including from about 15 weight percent to about 25 weight percent, based on the total weight of the liquid detergent composition.

The self-preserved liquid detergent of the present disclosure also comprises at least one surfactant. The at least one surfactant is typically present in the detergent composition in an amount up about 45 weight percent, including from about 5 weight percent to about 40 weight percent, and including from about 20 weight percent to about 35 weight percent, and including about 25 weight percent to about 30 weight percent In the present disclosure, all weight percentages are based on the total weight of the detergent composition unless otherwise specified.

The at least one surfactant can include an anionic surfactant, a non-ionic surfactant, a cationic surfactant, a semi-polar surfactant, a zwitterionic surfactant or combinations thereof. In some embodiments, the at least one surfactant includes one or more nonionic and one or more anionic surfactants. In embodiments in which two or more surfactants are employed, the combination of surfactants can be referred to as a surfactant system. In some embodiments, including but not limited to a surfactant system comprised of a non-ionic surfactant and an anionic surfactant, a non-ionic surfactant is present up to about 40 weight percent, including from about 15 weight percent to about 35 weight percent, and including from about 20 to about 30 weight percent, including about 25 weight percent the weight percentages based on the total weight of the liquid detergent composition. In some embodiment, an anionic surfactant is present up to about 15 weight percent, including from about 2 to about 10 weight percent, and including from about 3 to about 7 weight percent, and including about 4 to about 6 weight percent, and including about 5 weight percent, the weight percentages based on the total weight of the liquid detergent composition.

In one embodiment, the level of fatty acid compounds for anti-foaming can be reduced and be present at up to about 5 weight percent, including from about 1 weight percent to about 3 weight percent.

In some embodiments, the at least one surfactant is an anionic surfactant. Non-limiting examples of anionic surfactants that can be employed in the present disclosure include sulfates and sulfonates, in particular, phenylalkanesulfonates, alpha-olefinsulfonates (AOS), olefin sulfonates, alkene sulfonates, alkane-2,3-diyIbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), or combinations thereof.

In some embodiments, the at least one surfactant is a nonionic surfactant. Non-limiting examples of nonionic surfactants that can be employed in the present disclosure include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA).

In some embodiments, the least one surfactant is a cationic surfactant. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, or combinations thereof.

In some embodiments, the at least one surfactant can include at least one semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, or combinations thereof. In some embodiments, the detergent composition of the present disclosure can include at least one zwitterionic surfactant. Non-limiting examples of zwitterionic surfactants that can be employed include betaines such as alkyldimethylbetaines, sulfobetaines, or combinations thereof.

In some embodiments, the at least one surfactant is an alcohol ethoxylate nonionic surfactant, such as a fatty alcohol ethoxylate C₁₂₋₁₅ 7EO.

In some embodiments, in addition to glycerin, a non-aqueous solvent (NAS) can be used. For clarity, the terms “non-aqueous solvent” or “NAS” as used herein do not include glycerin which, while a non-aqueous solvent, is considered a separate component in the liquid detergent composition of the disclosure. In some embodiments, the NAS is present in the liquid detergent composition in an amount from up about 40 weight percent, including from about 5 weight percent to about 35 weight percent, and including from about 25 weight percent to about 30 weight percent.

In some embodiments, the NAS may be chosen from ethanol; polyethylene glycol; polypropylene glycol; polypropylene glycol esters; polyethylene glycol esters such as polyethylene glycol stearate, polyethylene glycol laurate, and/or polyethylene glycol palmitate; methyl ester ethoxylate; diethylene glycol; dipropylene glycol; tetramethylene glycol; butylene glycol; pentanediol; hexylene glycol; heptylene glycol; octylene glycol; 2-methyl-1,3-propanediol; xylitol; mannitol; erythritol; dulcitol; inositol; adonitol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with the non-aqueous solvent has a weight average molecular weight of 4000 Daltons or less.

In some embodiments, the NAS is selected from polyethylene glycol; polyethylene glycol esters such as polyethylene glycol stearate, polyethylene glycol laurate, and/or polyethylene glycol palmitate; polyproylene glycol.

In some embodiments, the NAS is polyethylene glycol (“PEG”) and an ester thereof. The PEG can have a weight average molecular weight ranging, for example, from about 100 to about 4000 Daltons. Suitable PEGs can have a weight average molecular weight of, for example, about 300, about 400, about 500, about 600, about 700, about 800, about 900, about 1000, about 1100, about 1200, about 1300, about 1400, about 1500, about 1600, about 1700, about 1800, about 1900, about 2000, about 2100, about 2200, about 2300, about 2400, about 2500, or about 2600, about 2700, about 2800, about 2900, about 3000, about 3500, or about 4000 Daltons.

In one embodiment, alcohols such as ethanol can be employed at up to about 5 weight percent, including about 1 weight percent to about 3 weight percent.

In some embodiments, glycerin can be used in a blend with an NAS such as a polyethylene glycol, e.g. PEG 400. In other embodiments, the NAS is PEG 400 in an amount up to about 40 weight percent, including from about 5 weight percent to about 35 weight percent, and including from about 25 weight percent to about 30 weight percent.

In some embodiments, the detergent composition of the present disclosure can further include at least one enzyme. The at least one other enzyme can enhance the cleaning performance (including, for example, stain removal, redeposition of soil released in the washing/cleaning process, or restoration, fully or partially, the whiteness of a textile) of other components that are present in the detergent composition of the present disclosure. Exemplary enzymes include, but are not limited to, deoxyribonucleases (DNaeses), cellulases, proteases, lipases, cutinases, amylases, peroxidases, and/or oxidase.

In addition to the above-mentioned components, the detergent composition of the present disclosure can include any additional detergent component(s) that is known in the art. Other optional detergent components include, for example, beaching systems, anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, and wicking agents, either alone or in combination. Any component known in the art for use in detergents may be utilized. The choice of such optional components and the working amounts is well within the skill of the artisan.

In some embodiments, the detergent composition of the present disclosure can further include well known dye transfer agents, fluorescent whitening agents, soil release polymers, rheology modifiers or any combination thereof. In some embodiments, the detergent composition of the present disclosure can also include a fatty acid that has a formula R—C(O)OH, wherein R is a C₅-C₂₁ linear or branched aliphatic group. In one example, the fatty acid is dodecanoic acid (also known as coconut fatty acid).

The detergent composition of the present disclosure can be formulated utilizing techniques well known to those skilled in the art. The various components that provide the detergent composition of the present disclosure can be added in any order. The addition of the various components that provide the detergent composition of the present disclosure can be performed with continuous stirring. The addition is typically performed at room temperature, e.g., from about 20° C. to about 30° C.

In some embodiments, the amine buffer and/or the inorganic pH adjusting agent is present in an amount effective such that the final pH of the self-preserved liquid detergent composition is about 6 to about 9, including about 7 to about 8, e.g. about 7.7. In some embodiments the amine buffer and/or the inorganic pH adjusting agent is present up to about up to about 3 weight percent, including from about 0.05 to about 2 weight percent, and including from about 0.1 to about 1 weight percent, and including from about 0.15 to about 1.5 weight percent, based on the total weight percent of the self-preserved liquid detergent composition.

Examples have been set forth below for the purpose of further illustrating the present disclosure. The scope of the present disclosure is not limited to any of the examples set forth herein.

### Example 1

Concentrated self-preserved liquid detergent compositions according to the disclosure were prepared. These liquid detergent compositions were prepared by mixing the components in the amounts listed in Table 1 in a standard overhead mixer. In this Example 1, Formulas 1, 2, and 3 represent practices of the present disclosure. In Formulas 1, 2, and 3, the non-aqueous solvent used to formulate the detergent compositions was a blend of glycerin and polyethylene glycol, PEG 400. No LAS or propylene glycol or any preservatives where used in the detergent compositions. The liquid detergent compositions were created with a target pH of 7.7. In this Example 1, a Comparative Example (CE1) formulation was prepared mixing the components in the amounts listed in Table 2 and which CE1 contained LAS and propylene glycol.

TABLE 1

| | | | | Formula 3 |
|---|---|---|---|---|
| | | | Formula 2 | wt. % in |
| | | | wt. % in | Formula |
| | Activity | Formula 1 | Formula | (Inventive, |
| | of Raw | wt. % in | (Inventive, | Enzymes and |
| COMPONENT | Material | Formula | Enzymes) | Polymers) |
| Glycerin | 99+% | 19.23 | 18.37 | 17.27 |
| Alcohol Ethoxylate | 99+% | 24.13 | 24.13 | 24.13 |
| Non-ionic | | | | |
| Surfactant 25-7 | | | | |
| Propylene Glycol | 99+% | 0 | 0 | 0 |
| PEG400 | 99+% | 28.85 | 27.56 | 25.91 |
| Monethanolamine | 99+% | 1.4 | 1.4 | 1.4 |
| Water | 100 | 10.5 | 10.5 | 10.5 |
| LAS | 96 | 0 | 0 | 0 |
| Coconut Fatty Acid, | 100 | 8.08 | 8.08 | 8.08 |
| 34% iminodisuccinic | | | | |
| acid, 15% sodium | | | | |
| sulfite, 25% | | | | |
| bittering agent, | | | | |
| optical brightener | | | | |
| Alcohol | 70 | 4.8 | 4.8 | 4.8 |
| Ethoxysulfates | | | | |
| AES 3EO- 70% Paste | | | | |
| Polyethyleneimine | 80 | 0 | 0 | 6 |
| Ethoxylate Polymer | | | | |
| Amylase, protease, | 100 | 0 | 2.15 | 2.15 |
| mannanase Enzymes | | | | |
| Denatured alcohol | 100 | 3 | 3 | 3 |
| Ethanol (200 Proof) | | | | |
| | | 100.00 | 100.00 | 100.00 |

TABLE 2

| | | wt. % in Formula CE1 |
|---|---|---|
| COMPONENT | Activity | (Comparative, LAS) |
| Glycerin | 99+ | 14.73 |
| Alcohol Ethoxylate | 99+ | 23.07 |
| non-ionic surfactant | | |
| Propylene Glycol | 99+ | 8.20 |
| PEG400 | 99+ | 5.8 |
| Monethanolamine | 99+ | 4.80 |
| Water | 100.00 | 10.5 |
| LAS | 96.00 | 17 |
| Coconut Fatty Acid, | 100.00 | 8.08 |
| Iminodisuccinic Acid, | | |
| 15% Sodium Sulfite, | | |
| 25% Bittering agent, | | |
| optical brightener | | |
| Alcohol Ethoxysulfates | 70.00 | 4.8 |
| 3EO- 70% Paste | | |
| Denatured alcohol | 100.00 | 3 |
| Ethanol (200 Proof) | | |
| | | 100.00 |

### Stain Removal Performance

Formula 2 and CE1 were tested for stain removal performance against a variety of stains (18.8 grams of each of Formula 2 and CE1). SRI is the well known Stain Removal Index. The following results were observed using a High Efficiency Toploader with the washing water at 59° F. and 90° F. Only stain differences that were significant were reported in Table 3. As seen, of the stains tested, Formula 2 of the disclosure outperformed CE1 in all cases but one.

TABLE 3

| | | 90F | | | 59F | | |
|---|---|---|---|---|---|---|---|
| | | SRI | | Difference | SRI | | Difference |
| | | Formula | | Formula 2 | Formula | | Formula 2 |
| | | CE1 | | minus CE1 | CE1 | | minus CE1 |
| | | (LAS) | Formula 2 | SRI Score | (LAS) | Formula 2 | SRI Score |
| Blood | KC | 80.88 | 84.05 | 3.17 | 80.66 | 81.56 | 0.90 |
| | Poly | 95.79 | 98.52 | 2.73 | 98.53 | 98.85 | 0.32 |
| Chocolate | KC | 83.98 | 94.05 | 10.07 | 84.01 | 89.22 | 5.20 |
| Ice cream | | | | | | | |
| Coffee | Poly | 96.68 | 97.88 | 1.19 | 96.88 | 97.59 | 0.70 |
| Grape Juice | Poly | 94.52 | 95.89 | 1.37 | 95.00 | 96.46 | 1.46 |
| Grass | KC | 63.98 | 66.26 | 2.27 | 63.07 | 64.61 | 1.54 |
| | Poly | | | | 78.64 | 71.25 | −7.39 |
| Mud | Poly | 94.82 | 95.69 | 0.87 | | | |

### Zein Test

Formula 1 and CE1 were tested for Zein scores. The Zein test measures the skin irritancy potential of a surfactant composition. Zein scores are known in the art, as disclosed e.g. in U.S. Published Patent Application No. 2018/0016523. The Zein test determines the extent of denaturation of Zein corn protein after exposure to a surfactant for a given period of time. Generally, the higher the Zein score, the greater the skin irritation potential. Zein score was measured using a Zein test as described in Gott, E., Aesthet. Medzin., Tenside 15:313 (1966).

Results: Comparative Formula CE1 received a Zein score of 2.27% (i.e., 2.27% of the Zein was dissolved). Formula 2 of the disclosure received a Zein score of 0.32%, which was lower (preferred) than the 2.27% Zein score for CE1. After performing the known Tukey Analysis, the Zein scores were concluded to be significantly different from one another with Formula 2 of the disclosure being much preferred for mildness than CE1. Formula 5 defined in Table 4 was also tested at 0.3% dilution with resultant Zein scores of 0.44% and 0.38%, for an average of 0.41% which is indicative of good mildness for this formulation.

### Example 2

Concentrated self-preserved liquid detergent compositions according to the disclosure were prepared. These liquid detergent compositions were prepared by mixing the components in the amounts listed in Table 4 in a standard overhead mixer. In this Example 2, Formulas 4, 5, 6, 7, 8, and 9 represent practices of the present disclosure and do not contain LAS, propylene glycol, or preservatives. Target pH for Formulas 4 to 9 was 7.7. The pH was adjusted if needed with MEA or CFA to meet the target.

TABLE 4

| | Formula 4 | Formula 5 | Formula 6 | Formula 7 | Formula 8 | Formula 9 |
|---|---|---|---|---|---|---|
| Dose (g) | 23.51 g | 18.8 g | 15.6 g | 23.51 g | 18.8 g | 15.6 g |
| Dose (fluid oz) | 0.75 | 0.60 | 0.50 | 0.75 | 0.60 | 0.50 |
| Water Activity | — | 0.73 | 0.74 | — | 0.74 | — |
| Density | — | 1.11 | — | — | 1.10 | — |
| (approximate, g/mL) | | | | | | |
| Viscosity (cP), | — | 300 | — | — | 300 | — |
| approximate | | | | | | |
| Concentration | 2x | 2.5x | 3x | 2x OXI | 2.5x OXI | 3x OXI |
| COMPONENT | wt. % in Formula | | | wt. % in Formula | | |
| Glycerin | 27.96 | 24.70 | 20.75 | 24.73 | 20.85 | 16.10 |
| Alcohol Ethoxylate | 21.07 | 25.00 | 30.12 | 21.07 | 25.00 | 30.12 |
| Non-ionic Surfactant | | | | | | |
| 25-7 | | | | | | |
| Sorbitol 70% | 20.00 | 20.00 | 20.00 | 20.00 | 20.00 | 20.00 |
| Solution | | | | | | |
| MEA | 0.17 | 0.20 | 0.24 | 0.17 | 0.20 | 0.24 |
| Water | 22.88 | 20.21 | 16.97 | 20.23 | 17.06 | 13.18 |
| 50/50 Blend of | 0.00 | 0.00 | 0.00 | 5.88 | 7.00 | 8.43 |
| alkoxypolyethyleneim | | | | | | |
| ine (APE) polymer | | | | | | |
| and ethoxylated | | | | | | |
| ployethyleneimine | | | | | | |
| polymer | | | | | | |
| Alcohol | 4.00 | 5.00 | 6.02 | 4.00 | 5.00 | 6.02 |
| Ethoxysulfates AES | | | | | | |
| 3EO-70% Paste | | | | | | |
| Iminodisuccinic Acid | 3.92 | 4.8 | 5.9 | 3.92 | 4.9 | 5.9 |
| (34% active), | | | | | | |
| Enzymes (Protease, | | | | | | |
| Amylase, | | | | | | |
| Mannanase), Coconut | | | | | | |
| Fatty Acid | | | | | | |
| | 100.00 | 100.00 | 100.00 | 100.00 | 100.00 | 100.00 |

### Water Activity

Water activity, a_{w}=p/p₀, was determined at 25° C.

Target water activity in this Example 2 was 0.75. This was achieved using a 55 to 45 ratio of glycerin to water. As seen in Table 4, water activity was measured for Formulas 5, 6, and 8 and were 0.73, 0.74, and 0.74, respectively. If a water activity of 0.7 or lower is desired, then a higher ratio of glycerin to water would be used; if a water activity of 0.8 or more is desired, then a higher ratio of water can be used. As will be understood in the art, monoethanolamine (MEA) can be removed from the formulas herein and replaced with sodium hydroxide with the result that the formulation would no longer contain a buffer. Also as known in the art, additional solvents such as ethanol, glycol ethers and the like can be added to the formulas herein to adjust, e.g., lower, the viscosity as desired. As can be seen from Table 1 and Table 4, the inactive portions of Formulas 4 to 9 were adjusted based on Formulas 1 and 2, e.g. adding additional water and consolidating the solvents to glycerin, therefore the mildness and stain removal performance are expectedly the same.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A self-preserved liquid detergent composition comprising:
glycerin;
at least one saccharide derivative;
least one surfactant;
at least one amine buffer or an inorganic pH adjusting agent; and
water in an amount effective to provide a water activity of between about 0.65 to about 0.8, wherein the liquid detergent composition does not contain any of the following: (i) a linear alkylbenzene sulfonate, (ii) a preservative, and (iii) propylene glycol.

2. The self-preserved liquid detergent composition of claim 1 wherein the water activity is between about 0.65 to about 0.75.

3. The self-preserved liquid detergent composition of claim 2 wherein the water activity is about 0.66 to about 0.7.

4. The self-preserved liquid detergent composition of claim 1 wherein the water is present at about 10 wt % to about 40 wt % based on the total weight of the liquid detergent composition.

5. The self-preserved liquid detergent composition of claim 4 wherein the water is present at about 12 wt % to about 25 wt % based on the total weight of the liquid detergent composition.

6. The self-preserved liquid detergent composition of claim 1 wherein the glycerin is present in the detergent composition at about 15 wt % to about 30 wt %, based on the total weight of the liquid detergent composition.

7. The self-preserved liquid detergent composition of claim 1 wherein the ratio of glycerin to water is about 60 to about 40.

8. The self-preserved liquid detergent composition of claim 7 wherein the ratio of glycerin to water is about 55 to about 45.

9. The self-preserved liquid detergent composition of claim 1 wherein the saccharide derivative is comprises a non-reducing sugar or a sugar alcohol.

10. The self-preserved liquid detergent composition of claim 9 wherein the saccharide derivative comprises sorbitol, xylitol, mannitol, lactitol, isomalt, maltitol, a hydrogenated starch hydrolysate, sucrose, stachyose, verbascose, trehalose, raffinose or combinations thereof.

11. The self-preserved liquid detergent composition of claim 10 wherein the saccharide derivative comprises sorbitol.

12. The self-preserved liquid detergent composition of claim 9 wherein the saccharide derivative is present from about 15 wt % to about 25 wt %, based on the total weight of the liquid detergent composition.

13. The self-preserved liquid detergent composition of claim 1 wherein the at least one surfactant comprises a non-ionic surfactant.

14. The self-preserved liquid detergent composition of claim 13 wherein the non-ionic surfactant comprises an alcohol ethoxylate, an alcohol propoxylate, a propoxylated fatty alcohol, an alkoxylated fatty acid alkyl ester, an alkylphenol ethoxylate, a nonylphenol ethoxylate, an alkylpolyglycoside, an alkoxylated amine, a fatty acid monoethanolamide, a fatty acid diethanolamide, an ethoxylated fatty acid monoethanolamide, a propoxylated fatty acid monoethanolamide, a polyhydroxyalkyl fatty acid amide, a N-acyl N-alkyl derivative of glucosamine, or combinations thereof.

15. The self-preserved liquid detergent composition of claim 14 wherein the non-ionic surfactant comprises an alcohol ethoxylate.

16. The self-preserved liquid detergent composition of claim 1 wherein the amine buffer comprises monoethanolamine, triethanolamine, or combinations thereof.

17. The self-preserved liquid detergent composition of claim 1 wherein the inorganic pH adjusting agent comprises sodium hydroxide.

18. The self-preserved liquid detergent composition of claim 1 further comprising at least one enzyme selected from a deoxyribonuclease, a cellulase, a protease, a lipase, a cutinase, an amylase, a peroxidase, an oxidase, a mannanase, or combinations thereof.

19. The self-preserved liquid detergent composition of claim 1 further comprising an anionic surfactant.

20. The self-preserved liquid detergent composition of claim 19 wherein anionic surfactant comprises an alcohol ethoxysulfate.
